(19) United States
(12) Patent Application Publication
(10) Pub. No.: US 2015/0090388 A1
(43) Pub. Date: Apr. 2, 2015

(54) Exterior Member Attaching Device and Exterior Member Attaching Method

(71) Applicant: Yazaki Corporation, Tokyo (JP)

(72) Inventor: Yoshiaki Suzuki, Makinohara-Shi (JP)

(73) Assignee: YAZAKI CORPORATION, Tokyo (JP)

(21) Appl. No.: 14/566,096

(22) Filed: Dec. 10, 2014

Related U.S. Application Data
(63) Continuation of application No. PCT/JP2013/066536, filed on Jun. 11, 2013.

(30) Foreign Application Priority Data
Jun. 11, 2012 (JP) 2012-131588
Jun. 11, 2012 (JP) 2012-131589

(51) Int. Cl. H01B 13/26; H01B 13/012

(52) U.S. Cl. CPC H01B 13/2613; H01B 13/01263
USPC 156/54; 156/438

(57) ABSTRACT

An exterior member attaching device for attaching a sheet member to an electric wire of a wire harness, the sheet member being formed into a long sheet shape having an adhesive surface at one side and an exterior surface at the other side, includes a sheet member feeding portion that feeds the sheet member along a longitudinal direction of the sheet member while bending the sheet member so that the adhesive surface becomes inner side, a guiding portion that guides the sheet member fed from the sheet member feeding portion, an electric wire holding portion that holds the electric wire along the adhesive surface of the sheet member fed to the guiding portion, and a pressure applying portion that bends the sheet member into a folio and passes and pressurizes the sheet member which sandwiches the electric wire disposed along the adhesive surface.

### CROSS REFERENCE TO RELATED APPLICATIONS

This application is a continuation of PCT application No. PCT/JP2013/066536, which was filed on Jun. 11, 2013 based on Japanese Patent Applications (Nos. 2012-131588 and 2012-131589) filed on Jun. 11, 2012, the contents of which are incorporated herein by reference.

### BACKGROUND OF THE INVENTION

1. Field of the Invention

The present invention relates to an exterior member attaching device and an exterior member attaching method. More specifically, the present invention relates to an exterior member attaching device and method to assemble an exterior member to an electric wire part of a wire harness used in, for example, the internal wiring of an automobile, and an exterior member attaching device to attach an exterior member to an electric wire part of a wire harness used in, for example, the internal wiring of an automobile.

2. Description of the Related Art

Traditionally, various exterior members to cover and protect the electric wire part in a wire harness that is wired, for example, in an automobile are proposed (for example, refer to PTL 1 or PTL 2). The exterior member (protective material) described in PTL 1 is formed of a sheet made of vinyl chloride, and is attached to a wire harness by winding the sheet by hands around the periphery of the electric wire group, overlapping two end parts of the sheet in the winding direction, and welding the overlapped part by applying pressure and heat to the overlapped part with a heat press-bonding part of a heat welding machine. The exterior member (protective sheet) described in PTL 2 includes a rubber sheet and an adhesive layer which is formed on one surface of the rubber sheet, and is attached to a wire harness by winding the sheet by hands around the periphery of the electric wire group to adhere the adhesive layer to the electric wire group, and overlapping and adhering the adhesive layer at the terminal side to the sheet at the start side in the winding direction.

The wire harness is disposed two-dimensionally to nearly follow a wiring form when the wire harness is wired in, for example, an automobiles, and it is common that an exterior member is attached in such a disposed state. That is, as shown in FIGS. 5A and 12A, after a plurality of pre-harnesses whose terminal parts connectors C are connected to are set on a wiring board or the like, and electric wire parts W1 of the pre-harnesses are locked by locking pins or the like to be maintained in a predetermined wiring form, as shown in FIGS. 5B and 12B, a wire harness W is manufacture by attaching exterior members P to the electric wire parts W1 for every predetermined section, and fixing the ends of the exterior members P to the electric wire parts W1 with taps T. Therefore, in response to the procedures of manufacturing such a wire harness W, it is necessary to suitably attach exterior members to a predetermined electric wire part.
PTL 1 JP-A-11-007856
PTL 2 JP-A-2009-302023

### SUMMARY OF THE INVENTION

However, in the traditional attaching methods described in PTL 1 and PTL 2, since the sheet is wound and adhered one by one by the hands of an operator, there are problems that the operativity of the operation of attaching the exterior member is not improved, and that a sheet is wasted if the adhesive layer is adhered to an unintended site when the sheet is would. Therefore, it is expected to develop an attaching device which can efficiently attach an exterior member to a wire harness that is kept in a predetermined wiring form.

The present invention is made in view of the above points, and the object of the present invention is to provide an exterior member attaching device which can improve the efficiency of the operation of attaching an exterior member to a wire harness.

(1) According to an aspect of the invention, an exterior member attaching device for attaching a sheet member to an electric wire of a wire harness, the sheet member being formed into a long sheet shape having an adhesive surface at one side and an exterior surface at the other side, includes a sheet member feeding portion that feeds the sheet member along a longitudinal direction of the sheet member while bending the sheet member so that the adhesive surface becomes inner side, a guiding portion that guides the sheet member fed from the sheet member feeding portion, an electric wire holding portion that holds the electric wire along the adhesive surface of the sheet member fed to the guiding portion, and a pressure applying portion that bends the sheet member into a folio and passes and pressurizes the sheet member which sandwiches the electric wire disposed along the adhesive surface.
(2) The exterior member attaching device of (1) further includes a cutting portion that cuts the sheet member to a length corresponding to a length of the electric wire.
(3) In the exterior member attaching device of (1) or (2), the sheet member feeding portion includes a sheet member switching portion which switches and feeds a plurality of different sheet members.
(4) According to another aspect of the invention, an exterior member attaching device for attaching a sheet member to an electric wire of a wire harness, the sheet member being formed into a sheet shape which has an adhesive surface at one side, and an exterior surface at the other side, includes a pressing portion that includes a first pressing member and a second pressing member and sandwiches and presses the sheet member by the first pressing member and the second pressing member, a sheet member feeding portion that feeds the sheet member which is bent with the adhesive surface inward between the first pressing member and the second pressing member, and an electric wire holding portion that holds the electric wire along the adhesive surface of the sheet member fed to the pressing portion. The pressing portion press the sheet member so that the sheet member is bent to a folio and the electric wire part is sandwiched by the sheet member along the adhesive surface which is adhered to itself.
(5) The exterior member attaching device of (4) further includes a cutting portion which cuts the sheet member to a length corresponding to the length of the electric wire.
(6) In the exterior member attaching device of (4) or (5), the pressing portion has a base, the first pressing member which is fixed, and the second pressing member which is movably placed, the first pressing member has at least one first movable pressing member which is movably supported along the wiring direction of the electric wire, and the second pressing member has at least one second movable pressing member which is movably supported opposite to the first movable pressing member.
(7) According to another aspect of the invention, an exterior member attaching method for attaching a sheet member to an electric wire of a wire harness, the sheet member being formed into a long sheet shape having an adhesive surface at one side and an exterior surface at the other side includes feeding the sheet member along a longitudinal direction of the sheet member while bending the sheet member so that the adhesive surface becomes inner side, guiding the sheet member fed by the feeding step, holding the electric wire along the adhesive surface of the sheet member fed by the guiding step, bending the sheet member into a folio after the holding step, and pressurizing the sheet member which sandwiches the electric wire disposed along the adhesive surface.
(8) In the exterior member attaching method of (7) further includes cutting the sheet member to a length corresponding to a length of the electric wire.
(9) According to another aspect of the invention, an exterior member attaching method for attaching a sheet member to an electric wire of a wire harness, the sheet member being formed into a sheet shape which has an adhesive surface at one side, and an exterior surface at the other side includes feeding the sheet member which is bent with the adhesive surface inward between a first pressing member and a second pressing member, holding the electric wire along the adhesive surface of the sheet member fed by the feeding step, and pressing the sheet member so that the sheet member is bent to a folio and the electric wire part is sandwiched by the sheet member along the adhesive surface which is adhered to itself.
(10) In the exterior member attaching method of (9) further includes cutting the sheet member to a length corresponding to the length of the electric wire.

With the configurations of (1) and (7), the exterior member can be attached to the wire harness simply and surely. Even if the length of the exterior member gets longer, it is possible to perform the lamination by performing the pressurization uniformly with the pressure applying means, and the adhesion quality of the exterior member is stabilized. Furthermore, since an operator does not have to hold the wire harness at the time of assembling the exterior member because the electric wire of the wire harness is held by the electric wire holding means, the operation of attaching the exterior member can be performed efficiently.

With the configurations of (2) and (8), the exterior member can be attached to the wire harness that has the electric wire part of various lengths.

With the configuration of (3), by using sheet members of different kinds or different widths, the case that it is necessary to change the width of the sheet member due to the difference in the number of electric wires of the wire harness can be coped with.

With the configurations of (4) and (9), the exterior member can be attached to the wire harness simply, surely and efficiently, and the laminating quality of the exterior member can be stabilized. Furthermore, since an operator does not have to hold the wire harness because the electric wire of the wire harness is held by the electric wire holding means, the operation of attaching the exterior member can be performed efficiently.

With the configurations of (5) and (10), the exterior member can be attached to the wire harness that has the electric wire part of various lengths.

With the configuration of (6), the longitudinal length of the first pressing member and the second pressing member that press the exterior member can be changed, and can correspond to the change of the exterior member attached to the electric wire of the wire harness.

### BRIEF DESCRIPTION OF THE DRAWINGS

FIG. 1 is a schematic top view which shows a construction example of the first embodiment of the exterior member attaching device according to the present invention.

FIG. 2 is an A-A line sectional view in the exterior member attaching device of FIG. 1.

FIGS. 3A and 3B are figures which describe part of the construction in the exterior member attaching device of FIG. 1, in which FIG. 3A is a B-B line side view, and FIG. 3B is a C-C line sectional view.

FIG. 4 is a perspective view which shows an example of the wire harness to which exterior members are assembled with the exterior member attaching device.

FIGS. 5A and 5B show an example of the wire harness to which exterior members are assembled in a traditional manner, in which FIG. 5A is a figure before the assembly, and FIG. 5B is a figure after the assembly. (traditional embodiment)

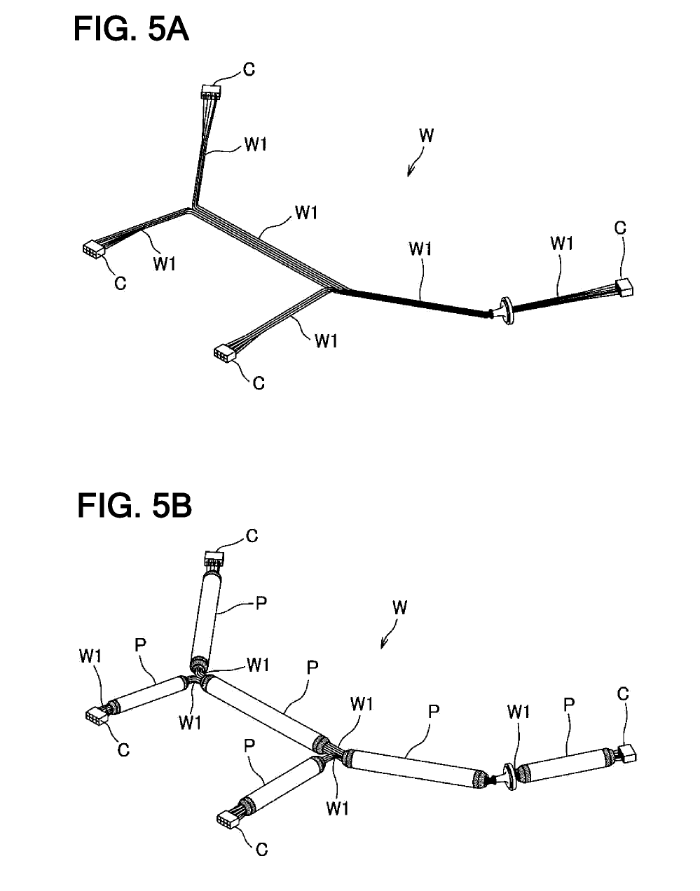

FIG. 6 is a schematic top view which shows a construction example of the second embodiment of the exterior member attaching device according to the present invention. (the second embodiment)

FIG. 7 is an A-A line sectional view in the exterior member attaching device of FIG. 6. (the second embodiment)

FIGS. 8A and 8B are figures which describe part of the construction in the exterior member attaching device of FIG. 6, in which FIG. 8A is a B-B line sectional view, and FIG. 3B is a C-C line side view.

FIGS. 9A and 9B are figures which describe a pressing operation in the exterior member attaching device of FIG. 7, in which FIG. 9A is a figure before the pressing operation, and FIG. 9B is a figure after the pressing operation. (the second embodiment)

FIG. 10 is a perspective view which shows an example of the wire harness to which exterior members are assembled with the exterior member attaching device of FIG. 7. (the second embodiment)

FIG. 11 is a schematic top view which shows a construction example of the third embodiment of the exterior member attaching device according to the present invention. (the third embodiment)

FIGS. 12A and 12B show an example of the wire harness to which exterior members are assembled in a traditional manner, in which FIG. 12A is a figure before the assembly, and FIG. 12B is a figure after the assembly. (traditional embodiment)

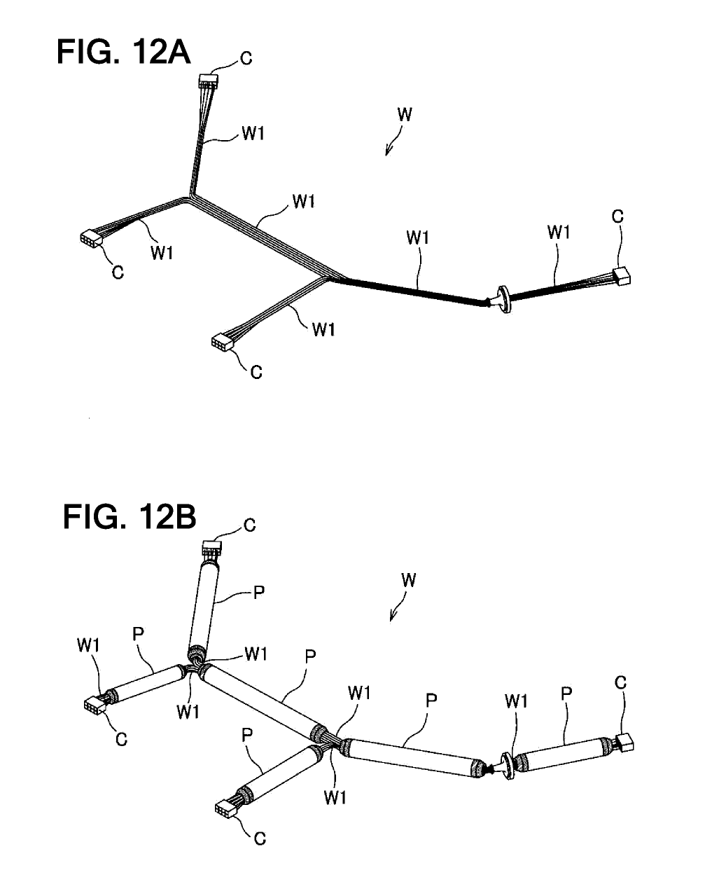

### DETAILED DESCRIPTION OF THE EXEMPLARY EMBODIMENTS

Next, embodiments of the invention are described with reference to the figures.

### First Embodiment

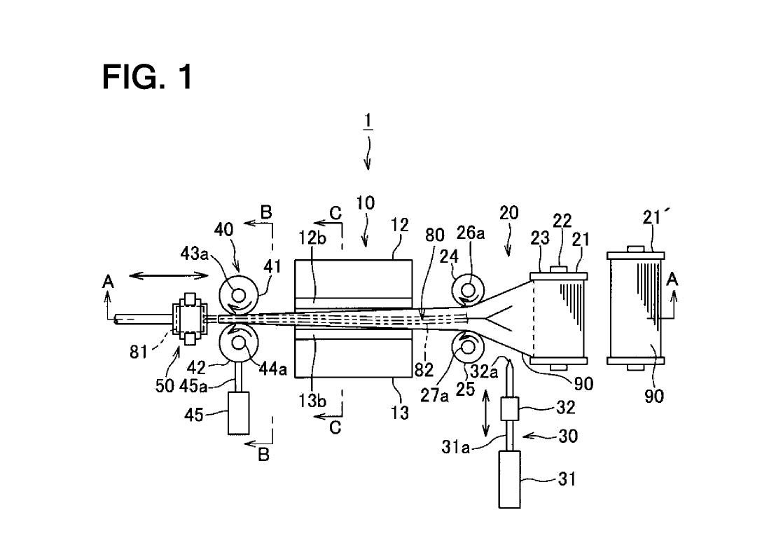

An exterior member attaching device according to the first embodiment of the present invention is described with reference to FIGS. 1 to 4. An exterior member attaching device 1 of the present embodiment is a device to attach a sheet member 90 which is an exterior member that covers an electric wire 82 of a wire harness 80 to the electric wire 82 in a manufacturing process of the wire harness 80. The exterior member attaching device 1 is able to attach the sheet member 90 to the portion of the electric wire 82 in each predetermined section in the wire harness 80. The sheet member 90 has a protective layer and an adhesive layer and is formed into a long sheet-like shape. When the sheet member 90 is folded with the adhesive surface inward and the exterior surface outward, and the adhesive surface is adhered to itself, the sheet member 90 thereby protects the electric wire 82 that is held within the sheet member 90.

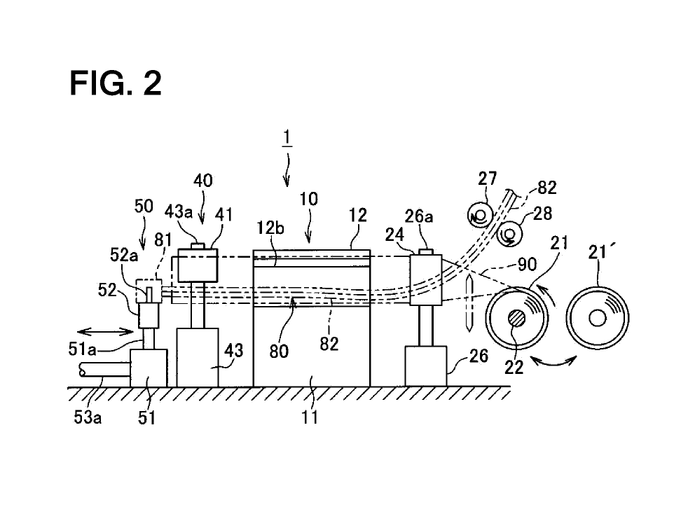

As shown in FIGS. 1 and 2, the exterior member attaching device 1 includes a guiding part 10 which is a guiding means, a sheet member feeding part 20 which is a sheet member feeding means, a sheet member cutting part 30 which is a cutting means, a pressure applying part 40 which is a pressure applying means, and a connector holding part 50 which is an electric wire holding means.

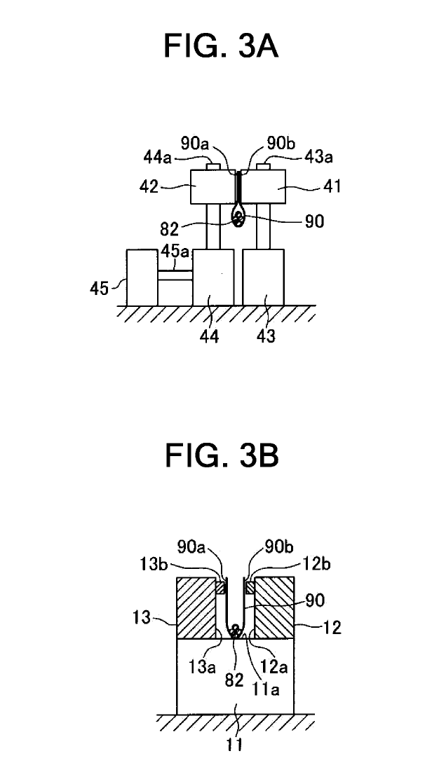

The guiding part 10 has a base 11, a first guiding member 12 which is fixed onto the base 11, and a second guiding member 13 which is fixed onto the base 11 to form a guiding channel between the first guiding member 12 and the second guiding member 13. The first guiding member 12 has a rectangular inside guiding surface 12a, and as shown in FIG. 3B, is provided with a rib-like guiding part 12b in the longitudinal direction at the upper part of the inside guiding surface 12a. The second guiding member 13 has a rectangular inside guiding surface 13a, and as shown in FIG. 3B, is provided with a rib-like guiding part 13b in the longitudinal direction at the upper part of the inside guiding surface 13a. The guiding parts 12b and 13b are provided at opposed positions.

The sheet member feeding part 20 is placed outside one end of the guiding part 10, and has a reel 21 around which the sheet member 90, which is formed into a long sheet-like shape as the exterior member, is wound, and sheet member feeding rollers 24 and 25. Between the sheet member feeding rollers 24 and 25, a nip part whose width is smaller than the width of the sheet member 90 is formed. The sheet member feeding roller 24 is fixed to a rotary shaft 26a of a driving motor 26, and the sheet member feeding roller 25 is fixed to a rotary shaft 27a of a driving motor not shown in the figure. The sheet member feeding rollers 24 and 25 transform the sheet member 90, which is drawn out from the reel 21, and whose release paper that covers the adhesive surface is released by a release paper removing part not shown in the figure, into a U shape at the nip part with the adhesive layer inward, and send the sheet member 90 along the longitudinal direction of the sheet member 90 between the inside guiding surface 12a of the first guiding member 12 and the inside guiding surface 13a of the second guiding member 13 in the guiding part 10 and onto a carrying surface 11a of the base 11.

The sheet member cutting part 30 is placed between the guiding part 10 and the sheet member feeding part 20, and cuts the sheet member 90 fed from the sheet member feeding part 20 to a length that corresponds to the length of the electric wire part to be protected. The sheet member cutting part 30 has a cylinder 31, and a cutter 32 which is operated by an actuator member 31a of the cylinder 31. A cutter blade 32a of the cutter 32, when being operated by the actuator member 31a of the cylinder 31, cuts the sheet member 90 in the widthwise direction.

The pressure applying part 40 is placed outside the other end of the guiding part 10, and has a pair of pressure applying rollers 41 and 42. Between the pressure applying rollers 41 and 42, a nip part to apply pressure the sheet member 90 is formed. The pressure applying roller 41 is fixed to a rotary shaft 43a of a driving motor 43, and the pressure applying roller 42 is fixed to a rotary shaft 44a of a driving motor 44. The driving motor 44 is connected to an actuator member 45a of a cylinder 45, and moves the pressure applying roller 42 with the cylinder 45 between a withdraw position and a pressure applying position.

The connector holding part 50 is placed at a position spaced from the pressure applying part 40 from the other end of the guiding part 10, and has a cylinder 51 and a chuck 52. The cylinder 51 operates chuck nails 52a of the chuck 52 with an actuator member 51a, and holds a connector 81 of the wire harness 80. Thereby, the connector holding part 50 works as an electric wire holding means to hold one end of the electric wire 82 connected to the connector 81.

Then, procedures to produce an exterior member attached wire harnesses using the exterior member attaching device of the above construction are described below.

(Procedure 1 . . . sheet member setting operation) The sheet member 90 is set in the guiding part 10. In particular, first, the sheet member 90 is unwound by hands from the reel 20 of the sheet member feeding part 20, and is inserted into the nip part of the sheet member feeding rollers 24 and 25. At this time, because the width of the nip part of the sheet member feeding rollers 24 and 25 is set to be smaller than the width of the sheet member 90, the sheet member 90 is bent into a U shape and is sent onto the base 11 between the inside guiding surface 12a of the first guiding member 12 and the inside guiding surface 13a of the second guiding member 13 in the guiding part 10. The sheet member 90 that is sent inside is cut into a length that corresponds to the length of the electric wire 82 to be protected with the operation of the cutting edge 32a of the cutter 32 of the cutting part 30, and is carried so that while the U-like bottom surface contacts the carrying surface 11a of the base 11, one end 90a in the longitudinal direction contacts the guiding member 13b of the second guiding member 13 and the area around the other end 90b contacts the guiding member 12b of the first guiding member 12 (refer to FIG. 3B).

(Procedure 2 . . . wire harness setting operation) The wire harness 80 is set in the guiding part 10. In particular, the electric wire 82 of the wire harness 80 passes through the nip part between the transporting rollers 27 and 28 that rotate freely and is transported to one end of the guiding part 10. The electric wire 82 is drawn out from the other end of the guiding part 10 along the inside adhesive surface of the sheet member 90 fed to the guiding part 10 (refer to FIG. 3B), and subsequently passes from below through the pressure applying rollers 41 and 42 of the pressure applying part 40 and is transported to the connector holding part 50. Then, the cylinder 51 of the connector holding part 50 is operated and makes the connector 81 connected to one end of the electric wire 82 of the transported wire harness 80 to be held by the chuck nails of the chuck 52 operated by the actuator member 51a. In this way, the wire harness 80 is set by placing the electric wire 82 along the adhesive surface of the U-shaped sheet member 90 on the base 11 between the inside guiding surface 12a of the first guiding member 12 and the inside guiding surface 13a of the second guiding member 13 of the guiding part 10. A state that the sheet member 90 and the wire harness 80 are set is shown in FIGS. 3A and 3B.

(Procedure 3 . . . pressure applying operation) Pressure is applied on the sheet member 90 that is set in the guiding part 10. In particular, the sheet member 90 in which the wire harness 80 is set is transported to the vicinity of the pressure applying rollers 41 and 42. Then, by operating the cylinder 45, and moving the driving motor 44 and the pressure applying roller 42, which were at the withdraw position before the pressure application, to the pressure applying position with the actuator member 45a of the cylinder 45, the sheet member 90 in which the wire harness 80 is set is sandwiched in the nip part of the pressure applying roller 41 and the pressure applying roller 42. Then, by driving the driving motors 43 and 44, the pressure applying rollers 41 and 42 are rotated, and the sheet member 90 which is sandwiched in the nip part of the pressure applying rollers 41 and 42 is pressurized and sent out to the side of the connector holding part 50. As a result, while the sheet member 90 is bent to a folio, the inside adhesive surfaces near the ends 90a and 90b are laminated by being pressurized, and are adhered (refer to FIG. 3A). The distance between the inside guiding surface 12a of the first guiding member 12 and the inside guiding surface 13a of the second guiding member 13 at the time of the adhesion is so set that the outer periphery of the electric wire 82 wrapped in the sheet member 90 will not deform.

(Procedure 4 . . . exterior member attached wire harness taking out operation) The finished exterior member attached wire harness 80 is taken out. More specifically, the wire harness 80 in which the sheet member 90 is pressurized and adhered is moved in a direction the connector part 50 which holds the connector 81 is taken out with a moving means not shown in the figure (leftward arrow direction of FIG. 1). Thereby, the operation of taking out the exterior member attached wire harness 80 is completed.

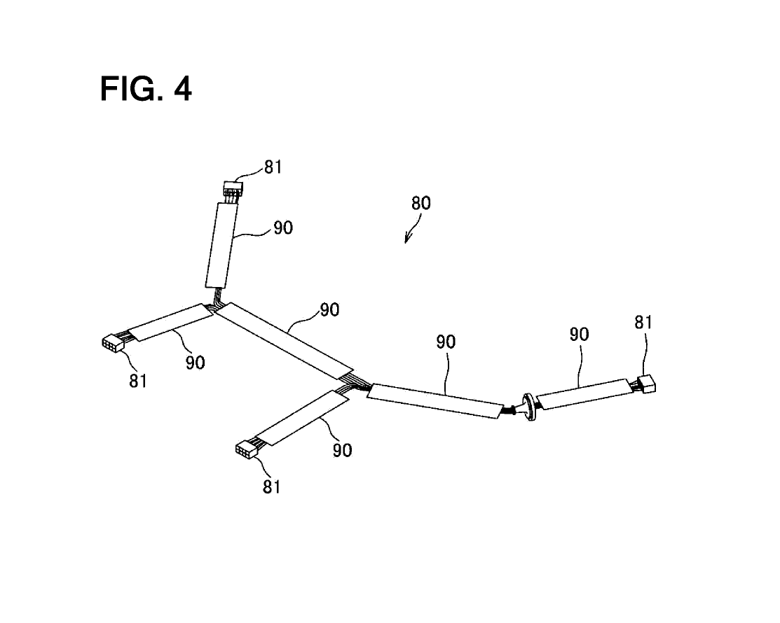

As described above, according to the present embodiment, when the sheet member 90 is guided in the guiding part 10, and passes through the pressure applying part 40 while being pressurized by the pressure applying part 40, the sheet member 90 is assembled to the electric wire 82 of the wire harness 80 simply and surely, and as shown in FIG. 4, the exterior member attached wire harness in which the electric wire 82 is protected by the sheet member 90 is manufactured. When the electric wire part to be protected gets longer, the sheet member to be attached gets longer, accordingly. If the sheet member is attached traditionally by hands, while a big force is necessary, the laminated part of the adhesive surfaces may be uneven, and the article may not be completed. However, according to the present embodiment, even if the electric wire part to be protected gets longer, and the length of the sheet member gets longer accordingly, the sheet member can be laminated collectively by being pressurized by the pressure applying rollers 41 and 42 of the pressure applying part 40, and the laminating quality of the exterior member is stabilized. Furthermore, since an operator does not have to hold the wire harness 80 at the time of assembling the sheet member because one end of the electric wire 82 is held by the connector holding part 50, the operation of assembling the sheet member 90 can be performed efficiently.

One embodiment of the present invention is described as above, but the present invention is not limited to this, and various changes and applications can be made.

For example, in the above-mentioned embodiment, the sheet member feeding rollers 24 and 25 in the sheet member feeding part 20 functions as a bending means which bends the sheet member into a U shape and a transporting means to transport the sheet member which was bent into the U shape, but the bending means and the transporting means may be provided separately.

In the above-mentioned embodiment, the connector holding part 50 that holds the connector 81 which is connected to one end side of the electric wire 92 is included as an electric wire holding means to hold the one end side of the electric wire 92, but when the exterior member is attached to the electric wire part whose two ends connectors are not connected to, an electric wire holding part that holds the one end side of the electric wire 92 may be provided.

Although the sheet member used as the exterior member in the above embodiment has the protective layer and the adhesive layer, a sheet member which adheres by pressure application (for example, a sheet member has a self-bonding property or a pressure-applied adhesive attached sheet member) or a sheet member which adheres by heat (for example, a hot melt attached sheet member) may be used. In the case of the heat adhesion, the guiding part is provided with a heating means.

The sheet member feeding part 20 may be constructed to include a sheet member switching means not shown in the figure, which switches the reel 21 to a reel 21′ around which a sheet member which is different in kind or width from the sheet member 90 which is wound around the reel 21. In this case, by using sheet members of different kinds or different widths, the case that it is necessary to change the width of the sheet member due to the difference in the number of electric wires of the wire harness can be coped with.

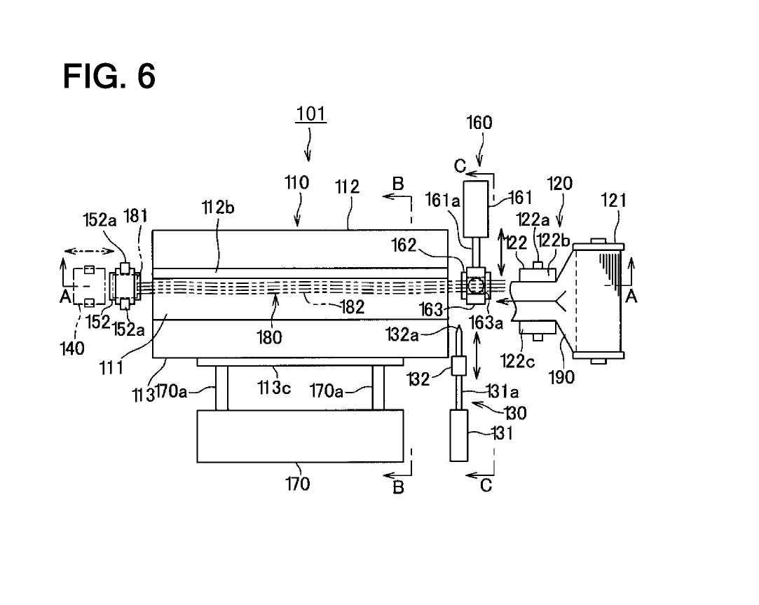

(The second embodiment) An exterior member attaching device according to the second embodiment of the present invention is described with reference to FIGS. 6 to 10. An exterior member attaching device 101 of the present embodiment is a device to attach a sheet member 190 which is an exterior member that covers an electric wire 182 of a wire harness 180 to the electric wire 82 in a manufacturing process of the wire harness 180. The exterior member attaching device 1 is able to attach the sheet member 190 to the portion of the electric wire 182 in each predetermined section in the wire harness 180. The sheet member 190 has a protective layer and an adhesive layer and is formed into a long sheet-like shape. When the sheet member 190 is folded with the adhesive surface inward and the exterior surface outward, and the adhesive surface is adhered to itself, the sheet member 190 thereby protects the electric wire 182 that is held within the sheet member 190.

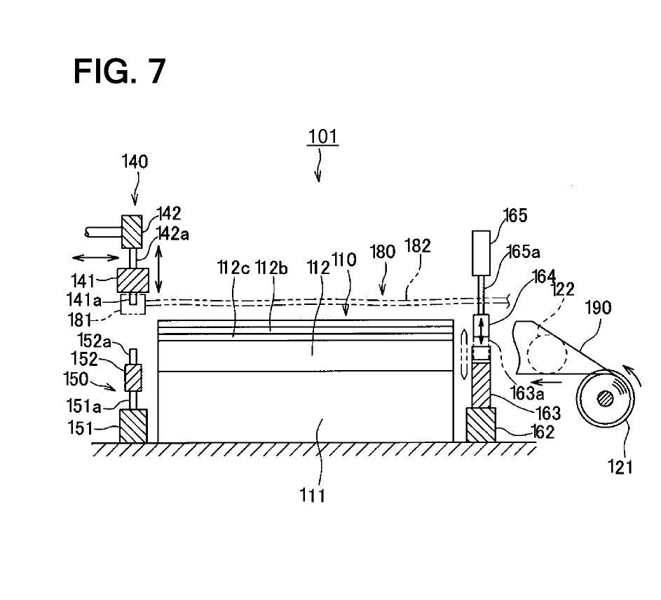

As shown in FIGS. 6 and 7, the exterior member attaching device 101 includes a pressing part 110 which is a pressing means, a sheet member feeding part 120 which is a sheet member feeding means, a sheet member cutting part 130 which is a cutting means, a connector transporting part 140 which is a connector transporting means, a connector holding part 150 and an electric wire holding part 160 which form an electric wire holding means.

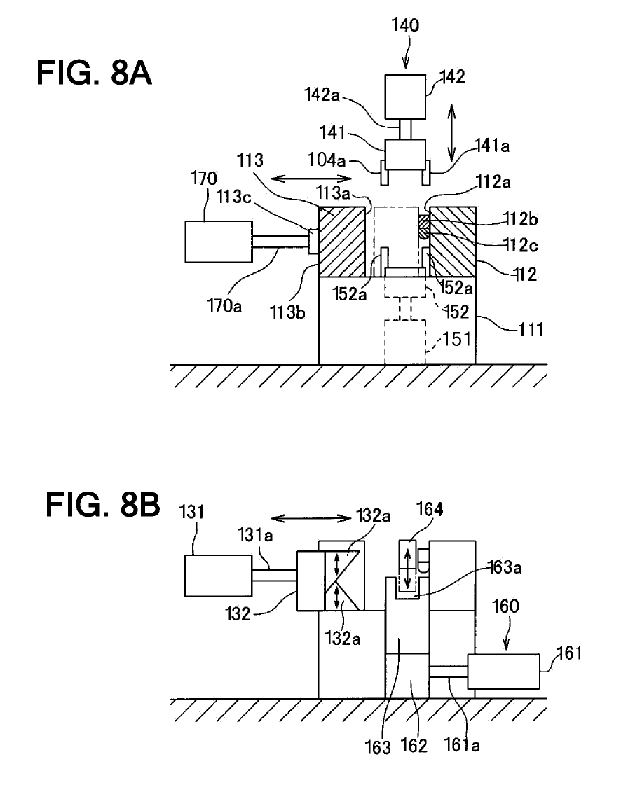

The pressing part 110 has a base 111, a first pressing member 112 which is fixed onto the base 111, and a second pressing member 113 which is movably arranged onto the base 111. The first pressing part 112 has a rectangular inside pressing surface 112a, and as shown in FIG. 8A is provided with a rib-like pressing part 112b in the longitudinal direction, at the upper part of the inside pressing surface 112a, and an assistant pressing part 112c made of a rib-like elastic body likewise in the longitudinal direction at the lower side of the pressing part 112b. The second pressing member 113 has a rectangular inside pressing surface 113a between which and the inside pressing surface 112a of the first pressing member 112 an object to be pressed is pressed, and an attaching part 113c which is fixed onto an outside opposite surface 113b opposed to the inside pressing surface 113a, is coupled to a pair of actuator members 170a which is straightly operated with an actuator 170 made of a linear motor as a moving means.

The sheet member feeding part 120 is placed outside one end of the pressing part 110, and has a reel 121 around which the sheet member 190, which is formed into a long sheet-like shape as the exterior member, is wound, and a transporting roller 122. The transporting roller 122 has two rollers 122b and 122c which are spaced a distance that is smaller than the width of the sheet member 190, and are attached to a rotary shaft 122a. The transporting roller 122 releases the release paper of the sheet member 190, which is drawn out from the reel 121, that covers the adhesive surface with a release paper removing part not shown in the figure, bends the sheet member 190 into a U shape with the adhesive layer inward, and send the sheet member 190 between the inside pressing surface 112a of the first pressing part 112 and the inside pressing surface 113a of the second pressing part 113 in the pressing part 110 and onto a carrying surface 111a of the base 111 as an object to be pressed.

The sheet member cutting part 130 is placed between the pressing part 110 and the sheet member feeding part 120, and cuts the sheet member 190 fed from the sheet member feeding part 120 to a length that corresponds to the length of the electric wire part to be protected. As shown in FIG. 8B, the sheet member cutting part 130 has a cylinder 131, and a cutter 132 which is operated by the cylinder 131. Two cutter blades 132a of the cutter 132, when being operated by an actuator member 131a of the cylinder 131, perform a cutting operation of scissors to cut the sheet member 190 in the widthwise direction.

The connector transporting part 140 is placed above outside the other end of the pressing part 110, has a chuck 141 and a cylinder 142, and works as a wire harness transporting means. When an actuator member 142a of the cylinder 142 is operated, the cylinder 142 moves upward/downward a chuck 141 (refer to arrows of FIG. 7) which holds a connector 181 of the wire harness 180 with chuck nails 141a. The cylinder 142 is connected to an actuator member of another cylinder not shown in the figure which, when being operated, mover the cylinder 142 to the right/left sides (refer to arrows of FIGS. 6 and 7).

The connector holding part 150 is placed outside the other end of the pressing part 110, and has a cylinder 151 and a chuck 152. The cylinder 151 operates chuck nails 152a of the chuck 152 with an actuator member 151a, and holds the connector 181 of the wire harness 180 which is transported by the connector transporting part 140. Thereby, the connector holding part 150 works as an electric wire holding means to hold one end of the electric wire 182 that is connected to the connector 181.

The electric wire holding part 160 is placed outside the other end of the pressing part 110 and between the sheet member cutting part 130 and the sheet member feeding part 120, and has a cylinder 161, a base 162, a holding member 163, a fitting member 164 and a cylinder 165. The cylinder 161 moves forward/backward the base 162 which is combined to an actuator member 161a (refer to arrows of FIG. 6). The holding member 163 is fixed onto the base 162, and a recess 163a is formed at the top surface of the holding member 163. The cylinder 165 holds the extension part of the electric wire 182 whose one end is connected to the connector 181 with the recess 163a and the fitting member 164 by raising or lowering the fitting member 164 with an actuator member 165a (refer to arrows of FIGS. 7 and 8B), and making the fitting member 164 to be fitted in the recess 163a of the holding member 163.

Then, procedures to produce an exterior member attached wire harnesses using the exterior member attaching device of the above construction are described below.

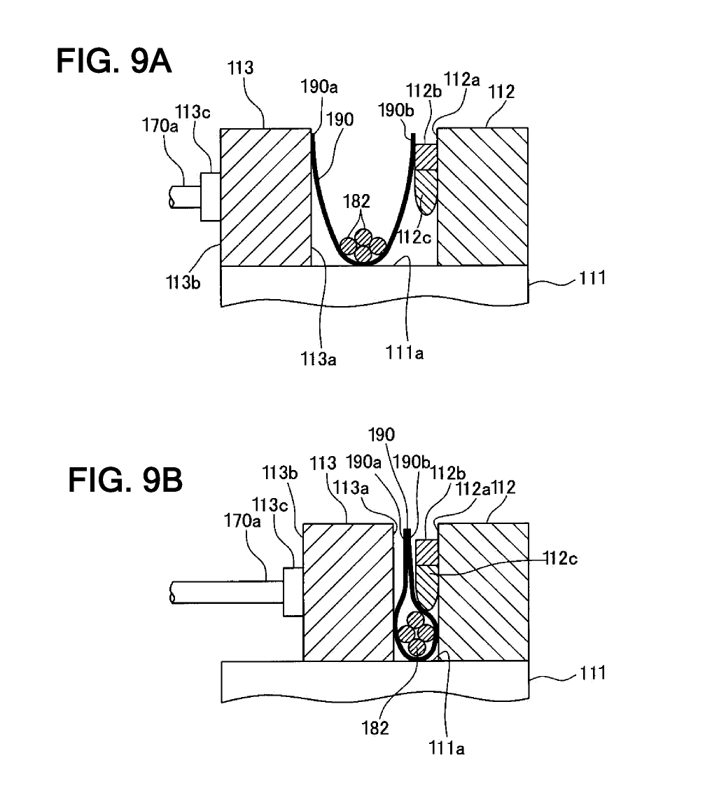

(Procedure 1 . . . sheet member setting operation) The sheet member 190 is set in the pressing part 110. In particular, first, the sheet member 190 is unwound by hands from the reel 120 of the sheet member feeding part 120, and is inserted between the rollers 122b and 122c of the transporting roller 122. At this time, because the axial distance between the roller 122b and the roller 122c is set to be smaller than the width of the sheet member 190, the sheet member 190 is bent into a U shape and is sent onto the base 111 between the inside pressing surface 112a of the first pressing part 112 and the inside pressing surface 113a of the second pressing part 113 in the pressing part 110. The sheet member 190 that is sent inside is cut into a predetermined length with the operation of the cutting edge 132a of the cutter 132 of the cutting part 130, and is carried so that while the U-like bottom surface contacts the carrying surface 111a of the base 111, one end 190a in the longitudinal direction contacts the inside pressing surface 113a of the second pressing member 113 and the area around the other end 190b contacts the pressing part 112b of the first pressing part 112 (refer to FIG. 9A). The base 162, the holding member 163 and the fitting member 164 of the electric wire holding part 160 becomes at the withdraw position so that the above sheet member setting operation will not be interfered. Finally, by operating the cylinder 161 of the electric wire holding part 160, the base 162 and the holding member 163 are moved from the withdraw position to the electric wire holding position with the movement of the actuator member 161a of the cylinder 161.

(Procedure 2 . . . wire harness setting operation) The wire harness 180 is set in the pressing part 110. More specifically, by operating the chuck 141 of the connector transporting part 140, the connector 181 of the wire harness 180 is held by the chuck nails 141a, and then by operating the cylinder 142, the chuck 142 which holds the connector 181 is moved downward, and the connector 181 is transported to the connector holding part 150. Then, while the connector 181 is held by the chuck nails 152a of the chuck 152 of the connector holding part 150, the holding of the chuck nails 141a of the chuck 141 is cancelled. Then, the extension part of the electric wire 182 of the wire harness 180 whose connector 181 is held by the connector holding part 150 is carried on the sheet member 190 which is sent onto the base 111 between the inside pressing surface 112a of the first pressing member 112 and the inside pressing surface 113a of the second pressing member 113 in the pressing part 110. Then, the electric wire 182 which protrudes from the pressing part 110 to the sheet member feeding part 120 is inserted into the recess 163a of the holding member 163 at the electric wire holding position of the electric wire holding part 160. Then, by operating the cylinder 165, the electric wire 182 is held by being moved from the withdraw position to the electric wire holding position by the actuator member 165a, and by making the fitting member 164 fitted in the recess 163a. In this way, the wire harness 180 is set by the connector holding part 150 and the electric wire holding part 160 by placing the electric wire 182 along the adhesive surface of the U-shaped sheet member 190 on the base 111 between the inside pressing surface 112a of the first pressing part 112 and the inside pressing surface 113a of the second pressing part 113 of the pressing part 110. A state that the sheet member 190 and the wire harness 180 are set is shown in FIG. 9A.

(Procedure 3 . . . pressing operation) The sheet member 190 that is set in the pressing part 110 is pressed. More specifically, by operating the actuator 170, the second pressing member 113 is moved in a direction (widthwise direction of the carrying surface 111a) of approaching the first pressing member 112 by the pair of actuator members 170a. With this movement, the part near the ends 190a and 190b of the sheet member 190 is pressed between the pressing part 112b of the first pressing member and the inside pressing surface 113a of the second pressing member 113. As a result, while the sheet member 190 becomes a folio, the inside adhesive surfaces near the ends 190a and 190b are pressurized and adhered (refer to FIG. 9B). The assistant pressing part 112c performs assistance to adhere the inside adhesive surfaces of the sheet member 190 near a position right above the electric wire bunch of the electric wire 182. The side sectional outline of the side of the assistant pressing part 112c apart from the pressing part 112b has a curved shape whose R is so assigned that the exterior surface of the sheet member 190 may not be hurt at the time of the adhesion. In this way, the exterior member attached wire harness 180 in which the sheet member 90 is attached to the electric wire 182 is completed. The distance between the inside pressing surface 112a of the first pressing part 112 and the inside guiding surface 113a of the second pressing part 113 at the time of the adhesion is so set that the outer periphery of the electric wire 182 wrapped in the sheet member 190 will not deform.

(Procedure 4 . . . exterior member attached wire harness taking out operation) The finished exterior member attached wire harness 180 is taken out. More specifically, by operating the cylinder 165 of the electric wire holding part 160, the holding member 164 is moved from the electric wire holding position to the withdraw position by the actuator member 165a of the cylinder 165. Thereby, the electric wire 182 in the electric wire holding part 160 becomes in a released state that the electric wire holding is canceled. Then, by operating the cylinder 151 of the connector holding part 150, the chunk nails 152a of the chunk 152 is released by the actuator member 151a and the holding of the connector 181 is canceled. Then, by operating the cylinder 142 of the connector transporting part 140, the chuck 141 is moved downward, and after the connector 181 is held by the chuck nails 141a, the chuck 141 is moved upwards. Then, by operating another cylinder not shown in the figure, the wire harness is transported in a direction (leftward arrow direction of FIG. 6) of taking out the cylinder 142 by the actuator member of the cylinder. Thereby, the operation of taking out the exterior member attached wire harness 180 is completed.

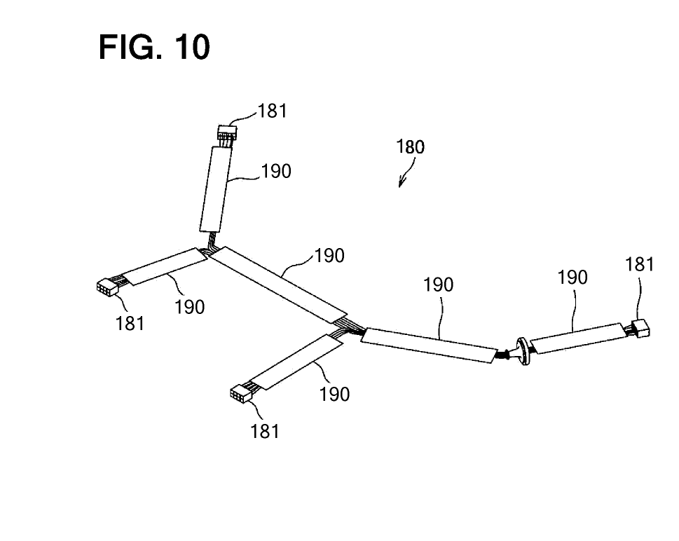

As described above, according to the present embodiment, when the sheet member 190 is pressed by the pressing part 110, the sheet member 190 is assembled to the electric wire 182 of the wire harness 180 simply and surely, and as shown in FIG. 10, the exterior member attached wire harness in which the electric wire 182 is protected by the sheet member 190 is manufactured. When the electric wire part to be protected gets longer, the sheet member to be attached gets longer, accordingly. If the sheet member is attached by hands, while a big force is necessary, the laminated part of the adhesive surfaces may be uneven, and the article may not be completed. However, according to the present embodiment, because the sheet member is laminated collectively by being pressurized, the laminating quality of the exterior member is stabilized. Further, since an operator does not have to hold the wire harness 180 at the time of assembling the sheet member because one end of the electric wire 182 is held by the connector holding part 150 and the extension part of the electric wire 182 is held by the electric wire holding part 160, the operation of assembling the sheet member 190 can be performed efficiently.

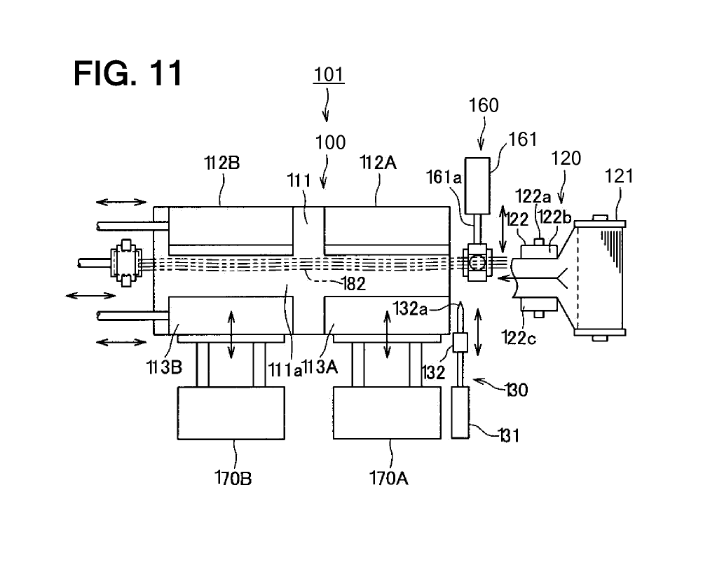

(The third embodiment) Next, the exterior member attaching device according to the third embodiment of the present invention is described with reference to FIG. 11. In the third embodiment, the construction of the pressing part 110 of the exterior member attaching device 1 is different from that of the second embodiment, and other constructions are the same as those of the second embodiment.

That is, the pressing part 110 in the third embodiment is constructed by dividing the first pressing member in the second embodiment into two pressing members, that is, a pressing member 112A which is fixed onto the base 111 and a first movable pressing member 112B which is supported on the base 111 to be movable in the longitudinal direction (longitudinal direction of the carried electric wire 182) of the carrying surface 111a of the base 111. Further, the pressing part 110 in the third embodiment is constructed by dividing the second pressing member in the second embodiment into two pressing members, that is, a pressing member 113A which is arranged onto the base 111 to be movable in the widthwise direction of the carrying surface 111a, and a second movable pressing member 113B which is supported on the base 111 to be movable to the first movable pressing member 112B in the widthwise and longitudinal direction of the carrying surface 111a. The movement of the first movable pressing member 112B in the longitudinal direction (the direction the electric wire 182 is wired) of the carrying surface 111a is carried out by another cylinder not shown in the figure. The movement of the pressing member 113A in the widthwise direction of the carrying surface 111a is carried out by the operation of a cylinder 170A. The movement of the pressing member 113B in the widthwise direction of the carrying surface 111a is carried out by the operation of a cylinder 170B. The movement of the pressing member 113B in the longitudinal direction (the direction the electric wire 182 is wired) of the carrying surface 111a is carried out by another cylinder not shown in the figure. The pressing part 110 is so constructed that while the pressing member 113B moves in the longitudinal direction of the carrying surface 111a, the cylinder 170B moves with the pressing member 113B.

With such a construction, even if the sheet member 190 to be attached gets longer in accordance with the length of the electric wire 182, since the adhesive surfaces are pressed and adhered by folding the sheet member 190 to a folio while the first movable pressing member 112B and the second movable pressing member 113B are moved from positions in contact with the pressing members 112A and 113A, the whole of the longer sheet member 190 can be attached to the electric wire 182 surely. In FIG. 11, each of the first and the second pressing members has one movable pressing member, but the first and the second pressing member may have two or more movable pressing members, respectively.

As described above, according to the present embodiment, the longitudinal length of the first pressing member and the second pressing member that press the sheet member 190 can be changed, and a pressing operation corresponding to the change of the length of the sheet member 190 to be attached to the electric wire 182 can be performed.

One embodiment of the present invention is described as above, but the present invention is not limited to this, and various changes and applications can be made.

For example, in the above-mentioned embodiment, a linear motor is used as a moving means to press the second pressing member, but other actuators such as cylinders may be used.

In the above-mentioned embodiment, the transporting roller 122 in the sheet member feeding part 120 functions as a bending means which bends the sheet member into a U shape and a transporting means to transport the sheet member which was bent into the U shape, but the bending means and the transporting means may be provided separately.

In the above-mentioned embodiment, the connector holding part 150 that holds the connector 181 which is connected to one end side of the electric wire 192 is included as an electric wire holding means to hold the one end side of the electric wire 192, but when the exterior member is attached to the electric wire part whose two ends connectors are not connected to, an electric wire holding part like the electric wire holding part 160 may be provided at the one end side of the embodiment 192. In this case, the connector transporting part 140 is changed to an electric wire transporting part.

Although the sheet member used as the exterior member in the above embodiment has the protective layer and the adhesive layer, a sheet member which adheres by pressure application (for example, a sheet member has a self-bonding property or a pressure-applied adhesive attached sheet member) or a sheet member which adheres by heat (for example, a hot melt attached sheet member) may be used. In the case of the heat adhesion, the pressing part is provided with a heating means.

There is provided with an exterior member attaching device which improves the efficiency of the operation of attaching an exterior member to a wire harness.

What is claimed is:

1. An exterior member attaching device for attaching a sheet member to an electric wire of a wire harness, the sheet member being formed into a long sheet shape having an adhesive surface at one side and an exterior surface at the other side, the exterior member attaching device comprising:
a sheet member feeding portion that feeds the sheet member along a longitudinal direction of the sheet member while bending the sheet member so that the adhesive surface becomes inner side;
a guiding portion that guides the sheet member fed from the sheet member feeding portion;
an electric wire holding portion that holds the electric wire along the adhesive surface of the sheet member fed to the guiding portion; and
a pressure applying portion that bends the sheet member into a folio and passes and pressurizes the sheet member which sandwiches the electric wire disposed along the adhesive surface.

2. The exterior member attaching device according to claim 1 further comprising a cutting portion that cuts the sheet member to a length corresponding to a length of the electric wire.

3. The exterior member attaching device according to claim 1, wherein the sheet member feeding portion includes a sheet member switching portion which switches and feeds a plurality of different sheet members.

4. An exterior member attaching device for attaching a sheet member to an electric wire of a wire harness, the sheet member being formed into a sheet shape which has an adhesive surface at one side, and an exterior surface at the other side, the exterior member attaching device comprising:
a pressing portion that includes a first pressing member and a second pressing member and sandwiches and presses the sheet member by the first pressing member and the second pressing member;
a sheet member feeding portion that feeds the sheet member which is bent with the adhesive surface inward between the first pressing member and the second pressing member; and
an electric wire holding portion that holds the electric wire along the adhesive surface of the sheet member fed to the pressing portion,
wherein the pressing portion press the sheet member so that the sheet member is bent to a folio and the electric wire part is sandwiched by the sheet member along the adhesive surface which is adhered to itself.

5. The exterior member attaching device according to claim 4 further comprising a cutting portion which cuts the sheet member to a length corresponding to the length of the electric wire.

6. The exterior member attaching device according to claim 4, wherein the pressing portion has a base, the first pressing member which is fixed, and the second pressing member which is movably placed,
the first pressing member has at least one first movable pressing member which is movably supported along the wiring direction of the electric wire, and
the second pressing member has at least one second movable pressing member which is movably supported opposite to the first movable pressing member.

7. An exterior member attaching method for attaching a sheet member to an electric wire of a wire harness, the sheet member being formed into a long sheet shape having an adhesive surface at one side and an exterior surface at the other side, the exterior member attaching method comprising:
feeding the sheet member along a longitudinal direction of the sheet member while bending the sheet member so that the adhesive surface becomes inner side;
guiding the sheet member fed by the feeding step;
holding the electric wire along the adhesive surface of the sheet member fed by the guiding step;
bending the sheet member into a folio after the holding step; and
pressurizing the sheet member which sandwiches the electric wire disposed along the adhesive surface.

8. The exterior member attaching method according to claim 7 further comprising cutting the sheet member to a length corresponding to a length of the electric wire.

9. An exterior member attaching method for attaching a sheet member to an electric wire of a wire harness, the sheet member being formed into a sheet shape which has an adhesive surface at one side, and an exterior surface at the other side, the exterior member attaching method comprising:
feeding the sheet member which is bent with the adhesive surface inward between a first pressing member and a second pressing member;
holding the electric wire along the adhesive surface of the sheet member fed by the feeding step; and
pressing the sheet member so that the sheet member is bent to a folio and the electric wire part is sandwiched by the sheet member along the adhesive surface which is adhered to itself.

10. The exterior member attaching method according to claim 9 further comprising cutting the sheet member to a length corresponding to the length of the electric wire.
